(19) United States
(12) Patent Application Publication
(10) Pub. No.: US 2010/0115010 A1
(43) Pub. Date: May 6, 2010

(54) File attribute database, and a mixed-operating system computer system utilising such a file attribute database

(76) Inventors: Guy R. Anderson, Wichita, KS (US); Tommy W. Kirk, Wichita, KS (US); James E. Roney, Andover, KS (US); Donald K. Krueger, Wichita, KS (US)

Correspondence Address: NIXON & VANDERHYE, PC, 901 NORTH GLEBE ROAD, 11TH FLOOR, ARLINGTON, VA, 22203, US

(21) Appl. No.: 12/289,340

(22) Filed: Oct. 24, 2008

(51) Int. Cl. G06F 17/30

(52) U.S. Cl. 707/825; 707/E17.044; 707/E17.01

(57) ABSTRACT

A file database hosted on a first data processor and arranged to store metadata about files located in at least one of a file store under the control of a second data processor, and a remote file store.

### FIELD OF THE INVENTION

The present invention relates to a file attribute database, and to a mixed-operating system computer system network or computers including such a file attribute database.

### BACKGROUND OF THE INVENTION

A large enterprise might typically have a complex computing environment where many different applications may need access to shared data environments. Large shared file stores may, for example, be maintained on servers running Linux or UNIX operating systems. These may be long standing systems and hence an organisation may be resistant to significant change to these systems because of possible “knock on” effects to users, back-up and recovery operations.

Users connect to the servers across a LAN or WAN from a user workstation. The workstation may run an operating system similar to the server, i.e. may run on Linux, or may be a PC running a Windows operating system or an operating system for an Apple McIntosh.

The user may use applications—or a mixture of applications—that may limit the choice of operating systems. This often forces the user machine to run an operating system that is different from the server's operating system.

There becomes a need to share files between the server and the workstation. Furthermore the join needs to be as seamless as possible.

Some tools exist to allow a UNIX or Linux machine to present some or all of its storage to a Windows machine such that the storage looks like a drive or directory on the Windows machine. Such applications include SAMBA and Windows services for Linux, SFL, and services for UNIX, SFU.

Such services include rights control, and user name remapping such that users can authenticate to the network file system.

Once a user has established a mapping request to view the shared area it causes the UNIX or Linux operating system to investigate all directories, sub-directories and files in the shared area to determine their inter-relations and to present the directory tree to the Windows operating system and applications running on the user workstation.

Because the storage environment is remote, may change due to processes from other computers and often contains large numbers of files, this interrogation process frequently runs slowly.

### SUMMARY OF THE INVENTION

According to a first aspect of the present invention there is provided a file database hosted on a first data processor and arranged to store metadata about files located in a file store under the control of a second data processor, or a remote file store.

It is thus possible to provide a file attribute database arranged to store metadata about files located in a shared storage area such that software on a workstation can obtain data about files in the shared storage area from the file attribute database. Consequently it is possible to speed up user applications and operating system functions by holding data about remote files, i.e. metadata, such that this data—when available—can be used in place of data that would otherwise be obtained by investigating the directory structure (sometimes referred to as “walking the tree”) of the shared storage area.

Advantageously the metadata for a file includes at least one of the file location for the file, file size, date created, date last modified, created by information, modified by information, file status (such as read only). This list is not intended to be exhaustive. The metadata may also include the project or task that a file belongs to and the application(s) or user(s) that has worked with it.

The database may be updated by several methods. In a first approach a database loader application (or other suitable application) may monitor log files from one or more applications to track which files the application accesses, and to hold metadata relating to those files. This approach might also be implemented by an agent that watches interactions between an application and the operating system of the machine hosting it.

In an alternative approach an agent or a daemon (a background process) on the file server acts to report back to the database on a shared server or on the user's workstation about file accesses made by the user—or other users—such that in a multi-user machine environment a user's workstation can be appraised of changes to files made by other users using other computers.

Advantageously the file attribute database is made available to an application via a script that the application is able to execute. The script may be in a the form of a macro or a compiled application, and often the script or macro commands provided in an application have the capability to exchange data with other applications or executable objects, or can cause executable objects to be started.

The file attribute database may store its data in a tabular form or a predefined sequence such that the position of metadata within a file of metadata allows the database to determine what the metadata relates to, e.g. file location, name, and so on. As an example, the first item in “row” may be a file name, the second item might be the path to the file from a root directory, and so on.

Alternatively the metadata may be tagged, such as is known in XML to explicitly identify what the metadata relates to. This approach has the merit of allowing additional metadata to be added whilst allowing backward compatibility with earlier databases.

The file attribute database is particularly advantageous as it enables the deficiencies of Windows services for UNIX (SFU) or the read only access (ROA) UNIX file share to be addressed. This gives much quicker interrogation of paths to a file that has been used before. As such an application can request access to a file's metadata without invoking the ROA or SFU; both of which are slow because they “walk the tree” of the shared storage area in its entirety before returning metadata to the Windows workstation.

The metadata may be time and date stamped such that the files within the file structure can be calculated for a given point in time defined by a user or a process. This, to some extent, gives an ability to revert the filing system to the state it was in at an earlier time. Furthermore the ability to update the metadata based on time and date stamps enables the system to heal any failures that may have occurred due to network outages, etc.

According to a second aspect of the present invention there is provided a computer program for causing a programmable computer to operate a file attribute database according to a first aspect of the present invention.

According to a third aspect of the present invention there is provided a data processor system comprising a first data processor having a first operating system and a second data processor having a second operating system different from the first and controlling access to a file store, wherein one of the data processors further comprises a database containing data about files held in the file store.

In a preferred embodiment of the invention there is provided a computer system comprising a file store hosted via a computer having a first operating system and an application that uses a file in the file store, the application executing on a second computer having a second operating system different from the first, and where the first, the second or a further computer hosts a file attribute database that keeps data about files stored in the file store such that the application or second operating system can interrogate the file attribute database in preference to interrogating the file store.

### BRIEF DESCRIPTION OF THE DRAWINGS

The present invention will further be described by way of non-limiting example, with reference to the accompanying drawings, in which:

FIG. 1 schematically illustrates two data processors and storage within a mixed computing mode environment;

FIG. 2 schematically illustrates processes executing within a data processor operating in accordance with the present invention;

FIG. 3 schematically illustrates a further embodiment of the invention;

FIG. 4 shows a process for monitoring for events that require the database to be updated; and

FIG. 5 shows exemplary data processing operations within the database.

### DESCRIPTION OF PREFERRED EMBODIMENTS

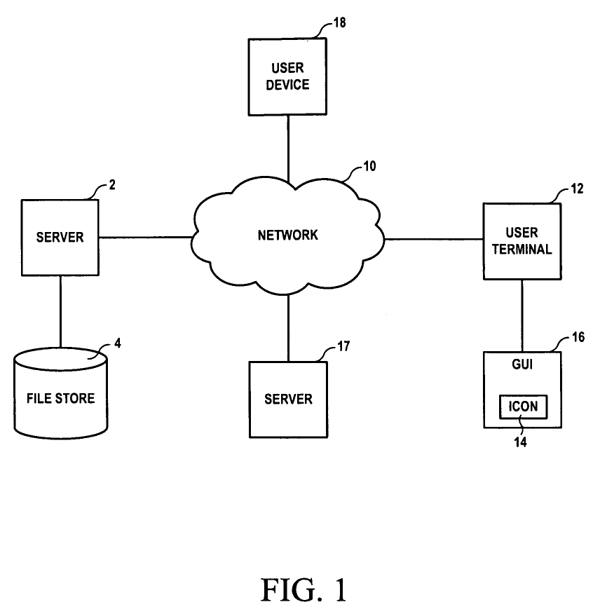

FIG. 1 schematically illustrates a data processing environment in which a server 2 controls access to a file store 4, which typically comprises one or more hard disk drives. The server runs an operating system which might be UNIX or Linux. The server 2 is a device on a network 10, which may be a local area network or a wide area network. The network may be a private network. Other devices, such as a user terminal 12 also connect to the network 10 and, depending on their securities and privileges, a user may be able to access services hosted by the server 2. The user terminal 12 might be a personal computer running an operating system which is different to that of the server. In this example we will assume that the user terminal is running a Microsoft Windows operating system. The user terminal 12 may be running or be capable or running one or more applications that require access to the file store 4.

Utilities such as Windows services for UNIX enable the file store 4 to appear as a mapped drive to the terminal 12 or simply allow an (internet protocol) IP address entry to enable them to browse to the server. The mapping can be presented as an icon 14 on a graphical user interface 16 of the terminal 12. Thus if the user clicks on the icon 14 a window opens which shows the contents of the file store 4.

However, in practice the process is not very quick as the terminal 12 invokes a SFU request to check the path, name and attribute of each and every file in the file store 4 before it presents data to the user of the terminal. This is because the file store 4 is a remote device and the terminal 12 does not have knowledge of changes being made to the file store. Consequently in an attempt to give the most accurate information possible it causes the file store to be examined each time it is requested to provide information about a file therein.

Where, for example, the file store holds many documents then the time to acquire this information may become unacceptably long. For a large computer aided design system with thousands of documents in the file store the access time can exceed a couple of minutes.

The inventors realised that users tend to work on specific projects and hence only access a small number of files on the file store. However company policy for sharing and backing up data may require that local copies of data are not made. Similarly to avoid two people working on different versions of a single document it is advantageous to only have one copy of the file and to rely on file locking of the file by the server 2 to ensure that only one person works on a file at a time.

The inventors realised that for most of the time they did not require extensive knowledge about most of the files in the file store 4. They realised that much of the information about the files that they routinely used could be held locally on the user terminal 12 or on another server and this information could in general be substituted in place of the information that would be obtained by the SFU request.

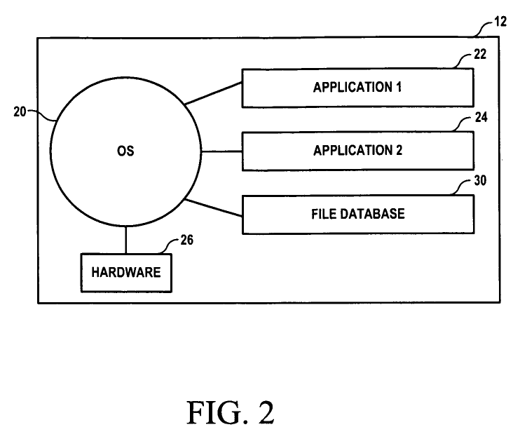

FIG. 2 schematically illustrates the processes running within a user terminal 12 constituting an embodiment of the present invention. The operating system provides a computing environment in which multiple applications 22 and 24 can run and call on hardware 26 without requiring detailed knowledge of the hardware.

In an embodiment of the present invention the computer 12 also hosts a file database 30 which is updated each time a relevant one of the applications modifies, reads or writes a file, either generally or just within a specified file store. Returning to FIG. 1, the network may contain other servers 17 and other user devices 18. Most of the time, one would expect multiple users 12 and 17 to be attached to the server 2.

Where multiple users are expected, then it makes more sense for the file database to be held on a shared database server 17. The database server may also host applications for client terminals, so the schematic diagram shown in FIG. 2 for the user terminal 12 is equally applicable to the server 17. Furthermore, some instances of databases enable multiple copies to exist on different hosts, and each copy of the database to keep up to date with the other instantiations of the database by an update process, which is often referred to as synchronisation or replication.

The file store generally is accessed by a file path, and the entire file path is advantageously stored within the file database, together with other attributes that are available from the file store, such as last modified date, file size and so on.

When one of the applications invokes any operation to list files in the file store or to access a file, the request to obtain information can be redirected to the file database 30, and information matching that request retrieved. This redirection can occur even if the user is working on the user device 12 or 18 and the file database 30 is held on the database server 17.

Thus if a user wanted to list files including a specific text string, which may for example represent a part or a project in a computer aided design system, then the query may initially be run on the file database 30. As all the data processing is internal to the database server 17 then the processing can be quick. The results can be displayed to the user, optionally with a message indicating that this was obtained from a search of the machine's database, and if the search does not contain the results that the user expects the user can be given the option to call the SFU facility to search the file store 4 directly.

Similarly when a user opens a list of files on the store 4 from within the application 22, the task of populating the list of files can be redirected by the operating system 20 to the file database 30. The database can then return a list of directories that it knows of and files within those directories. This data can then be presented by the application to the user. If the user locates or identifies the file they want they can select it in the normal way and metadata about the file, such as the path to access the file is transferred as an open file request from the terminal 12 to the server 2.

If the file exists it is opened and the file database 30 is updated. Similarly if the terminal 12 saves, copies a file or moves a file, then the file database 30 is updated. In some instances each save or copy may result in a new time stamped version of the file being saved. This allows for the possibility of rolling the metadata about a file back to an earlier version of itself.

If the file does not exist, then an error message is returned and a search of the file store 4 can be invoked, either by the user or automatically, to provide an up to date representation of files in the file store 4. This information is returned to the terminal 12 by the Windows services for UNIX application, and the data that is returned can be directed to the file database 30 to cause an update of the data therein.

It can be seen that if the file database 30 contains information about a file then the file access process is made significantly quicker. If the database does not contain information then the process of updating the data is the prior art process so the user is no worse off in terms of computing performance.

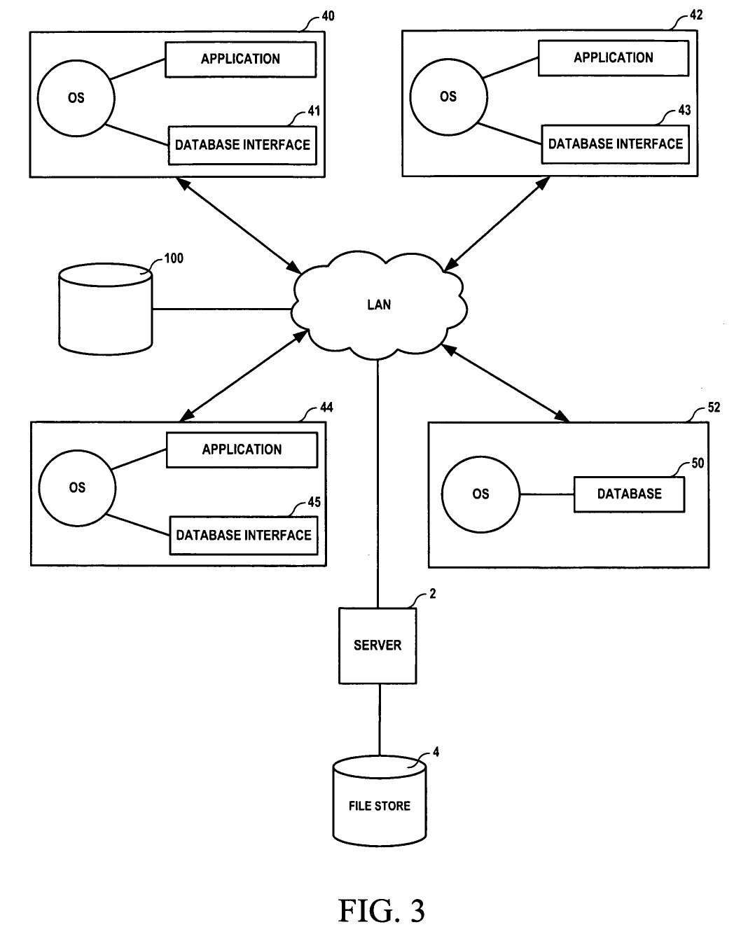

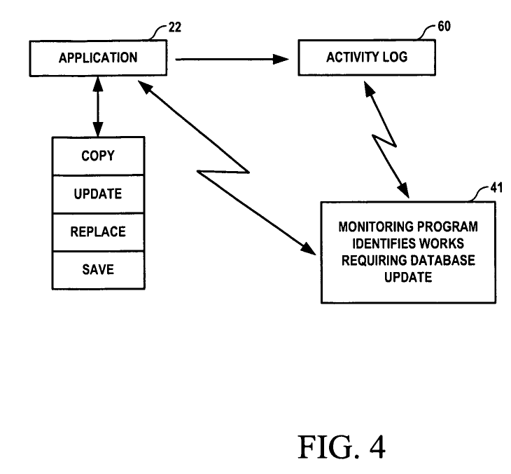

For the avoidance of doubt in an alternative embodiment, as shown in FIG. 3, multiple user terminals/computers 40, 42 and 44 can each run a database interface program 41, 43 and 45, respectively, that monitors applications seeking to perform open, write, copy and move activities on files located in the file store 4. The interface programs are adapted to co-operate with a database 50 which may be hosted on another computer 52. The computer 52 may be the database server 17 of FIG. 1. The network may also include a shared network storage area 100 with is not under the specific control of any single device.

Where an application 22 keeps an activity log, then rather than seeking to monitor calls to the operating system made by the application, the file database or the database interface 41 can inspect the activity log 60, as shown in FIG. 4, to identify items or activities that require the database to be updated. Similarly if one application seeks to monitor file level activity of another application these inspections can be made via the file database.

The activity log could be on the user terminals or could be maintained by the server 2. In distributed computing systems the database interface may be a process executing on the server and reporting back to the database 30 on a time driven or event driven basis.

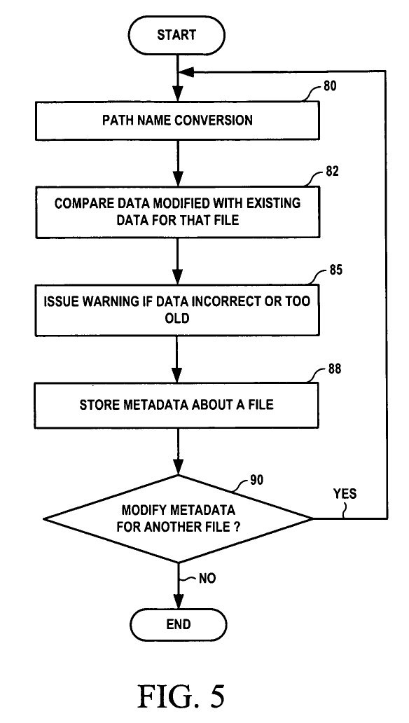

The database 30 may be adapted to perform several data manipulation functions. Suppose, for example that an application log file is being examined. The log file may originate from a local computer or a remote one. The database may need to convert path names to a common format to take account of different drive mappings, and may convert the name to the full path name for each file. Path delimiters may also need changing, for example the windows sub-directory symbol has a different meaning in UNIX, and maximum path length also varies between operating systems. Thus, at step 80 of FIG. 5 the database may convert the UNIX file path into a Windows file path. From step 80 the database progresses to step 82 where it examines the dates associated with a given file to compare creation and modified dates with comparable dates currently held in the database.

A warning may be issued at step 85 if, for example, the dates are inconsistent with expected system operation.

Metadata, such as modified path name, creation date, size and so on is then stored in the database at step 88.

At step 90 a test is made to see if more files have been accessed and hence if metadata for another file needs to be modified within the database. If another file is to be processed then control is passed to step 80 otherwise the data modification process can end.

The database contents may be refreshed by a background process which may run when the server 2 or computer 52 is idle or lightly loaded, or which may run on a schedule.

As noted before enquiries about the file location, name, and so on can thus be redirected to the database so as to be answered quickly rather than directed through Windows services for UNIX.

In some systems network storage devices are being deployed and these devices do not necessarily “belong” to any single computer or user. Thus as multiple computers might cause a change to data on the device it may become necessary to “walk the tree” on the network storage device to see what files are on it. Thus a file database in accordance with the present invention can be used to speed up access by removing the need to inspect the storage device in detail to see what changes may have occurred.

1. A file database hosted on a first data processor and arranged to store metadata about files located in at least one of a file store under the control of a second data processor, and a remote file store.

2. A file database as claimed in claim 1, in which the database is adapted to convert the metadata between a first form for presentation to a first operating system and a second form used by a second operating system at the second data processor.

3. A file database as claimed in claim 1, in which the file database can be inspected by applications running on the first data processor.

4. A file database as claimed in claim 1, in which the file database can be inspected by applications running on a further data processor or a further computing device.

5. A file database as claimed in claim 1, in which the database or a database agent monitors requests made to the first operating system to manipulate files, and updates the metadata.

6. A file database as claimed in claim 1, in which the database examines a log file kept by an application to determine which files have been manipulated, and updates the metadata.

7. A file database as claimed in claim 1, adapted to capture the time and date that files are created or modified so as to be able to represent the files as they would have been at a given point in time.

8. A data processor system including a file attribute database as claimed in claim 1.

9. A computer program product for causing a programmable computer to perform the operations of a file attribute database as claimed in claim 1.

10. A data processor system comprising a first data processor having a first operating system and a second data processor having a second operating system different from the first operating system and controlling access to a file store, wherein one of the data processors further comprises a database containing data about files held in the file store.

11. A data processing system as claimed in claim 10, in which the database is hosted on the first data processor.

12. A data processing system as claimed in claim 10, in which the database is hosted on a further data processor.

13. A data processing system as claimed in claim 12, in which the further data processor also uses the first operating system.

14. A data processing system as claimed in claim 10, in which the first operating system is a Microsoft Windows operating system.

15. A data processing system comprising a shared storage area and a database arranged to monitor events requiring access to the store such that the database holds data about files within the shared storage area.
